(19) United States
(12) Patent Application Publication
(10) Pub. No.: US 2007/0127085 A1
(43) Pub. Date: Jun. 7, 2007

(54) PRINTING SYSTEM, PRINTING METHOD AND PROGRAM THEREOF

(76) Inventor: Hiroshi MORI, Kawasaki-shi (JP)

Correspondence Address: MORGAN & FINNEGAN, L.L.P., 3 WORLD FINANCIAL CENTER, NEW YORK, NY, 10281-2101, US

(21) Appl. No.: 11/564,916

(22) Filed: Nov. 30, 2006

(30) Foreign Application Priority Data
Dec. 1, 2005 (JP) 2005-347936

(51) Int. Cl. H04N 1/00

(52) U.S. Cl. 358/403; 358/3.28

(57) ABSTRACT

A printing system, a printing method, and a program capable of preventing data embedded in an electronic document to be printed from increasing even if the amount of information relating to the electronic document to print become huge. To accomplish this, when a host computer 1200 issues a print command for printing an electronic document, the system is searched for the original electronic document and the electronic document found is printed on a printer (MFP 100). Information relating to the electronic document is obtained and written in a file. The file in which the information has been written is stored in a predetermined location in the system. Then, print image of the electronic document to which an image of the storage location of the file is added is generated and the print image is printed out on a printing medium.

### BACKGROUND OF THE INVENTION

1. Field of the Invention

The present invention relates to a printing system which combines and prints out multiple electronic documents.

2. Description of the Related Art

There has been a technique of embedding information about the location of electronic data to be printed in a print image as additional information such as a barcode and printing the print image (Japanese Patent Laid-Open No. H09-37004). When the image printed on paper with the embedded additional information is copied, the information about the location of the original electronic data is extracted from the scanned additional information. The original electronic data is then obtained from the location indicated by the extracted location information and reused to reprint.

However, as the amount of embedded information becomes huge, the amount of added image information increases and the function can become impossible to implement.

### SUMMARY OF THE INVENTION

The present invention enables to provide a printing system, a printing method, and a program thereof that prevents data embedded in an electronic document to be printed from increasing if the amount of information relating to the electronic document becomes huge.

According to one embodiment of the present invention, the foregoing problem is solved by providing a printing system printing an electronic document that is a combination of a plurality of electronic documents on a printer, comprising a writing unit adapted to write a related information relating to the plurality of electronic documents that includes storage location information of the plurality of the electronic documents into a file, a storage unit adapted to store the file in the printing system, an adding unit adapted to generate, on the basis of the plurality of electronic documents according to the related information, a print image of the electronic document to which an image of the storage location of the file is added, and a print unit adapted to print and output the print image on a printing medium.

The writing unit may write storage location information of a particular page of the electronic document into the file as the related information.

The writing unit may write layout information of the electronic document into the file as the related information.

The writing unit may write into the file layout information used when a plurality of print jobs to be printed are combined and printed out, as the related information.

The storage unit may store the file in a storage device held by a host computer that has issued a print command to print the electronic document.

The storage unit may store the file in a storage medium held by the printer that prints out the print image.

The adding unit may add the storage location information of the file to the electronic document by using a barcode.

The adding unit may add the location information of the file to the electronic document as an image hardly visible to human eye.

The printing system may further comprises an image obtaining unit adapted to scan the print medium printed out by the printing unit to obtain image information, an added image extracting unit adapted to extract the storage location information of the file added by the adding unit from the image information and a file obtaining unit adapted to obtain the file written by the writing unit from the storage location identified by the storage location information.

The printing system may further comprises a print information obtaining unit adapted to obtain print information required for printing the plurality of electronic documents from the file obtained by the file obtaining unit, and a second printing unit adapted to search for and print the plurality of electronic documents on the basis of the print information.

The print information obtaining unit obtains storage location information and layout information of a particular page of the electronic document.

According to one embodiment of the present invention, the foregoing problem is solved by providing a printing method in a printing system printing an electronic document that is a combination of a plurality of electronic documents on a printer, comprising the steps of writing related information relating to the plurality of electronic documents that includes storage location information of the plurality of electronic documents into a file, storing the file in the printing system, generating, on the basis of the plurality of electronic documents according the related information, a print image of the electronic document to which an image of the storage location information of the file is added, and outputting the print image on the printer to print out the print image on a printing medium.

Further features of the present invention will become apparent from the following description of exemplary embodiments with reference to the attached drawings.

### BRIEF DESCRIPTION OF THE DRAWINGS

FIG. 1 is a block diagram showing an exemplary configuration of a printing system according to one embodiment of the present invention;

FIG. 2 is a block diagram showing a configuration of an MFP 100 according to one embodiment of the present invention;

FIG. 3 shows a configuration of a computer which can function as a host computer 1200 such as a management PC 101 and a client PC 102;

FIG. 4 is a block diagram showing a configuration of a typical printing system including a host computer 1200 to which a printer such as an MFP 100 is connected directly or through a network;

FIG. 5 is a block diagram showing a configuration of a system that is an extended version of the typical printing system including a host computer 1200 shown in FIG. 4;

FIG. 6 is a flowchart illustrating a printing process performed in the printing system shown in FIG. 5;

FIG. 7 is a block diagram showing a configuration of an extended version of the typical printing system including a host computer 1200 shown in FIG. 4;

FIG. 8 is a block diagram showing another configuration of the extended version of the typical printing system including a host computer 1200 shown in FIG. 7;

FIG. 9 is a flowchart illustrating a reprinting process performed in a printing system according to one embodiment of the present invention;

FIG. 10 shows an exemplary image data processing in a block selection processing;

FIG. 11 is a block diagram showing block information recognized by block selection processing;

FIG. 12 is a flowchart of a process for decoding a two-dimensional barcode (QR code symbol) embedded in an original image to output a data character string;

FIG. 13 shows an exemplary original 521 to which a two-dimensional barcode is added; and

FIG. 14 is a flowchart illustrating details of a process for searching for an electronic file by using pointer information performed at step S305 described with reference to FIG. 9.

### DESCRIPTION OF THE EMBODIMENTS

A preferred embodiment of the present invention will now be described in detail with reference to the drawings. It should be noted that the relative arrangement of the components, the numerical expressions and numerical values set forth in these embodiments do not limit the scope of the present invention unless it is specifically stated otherwise.

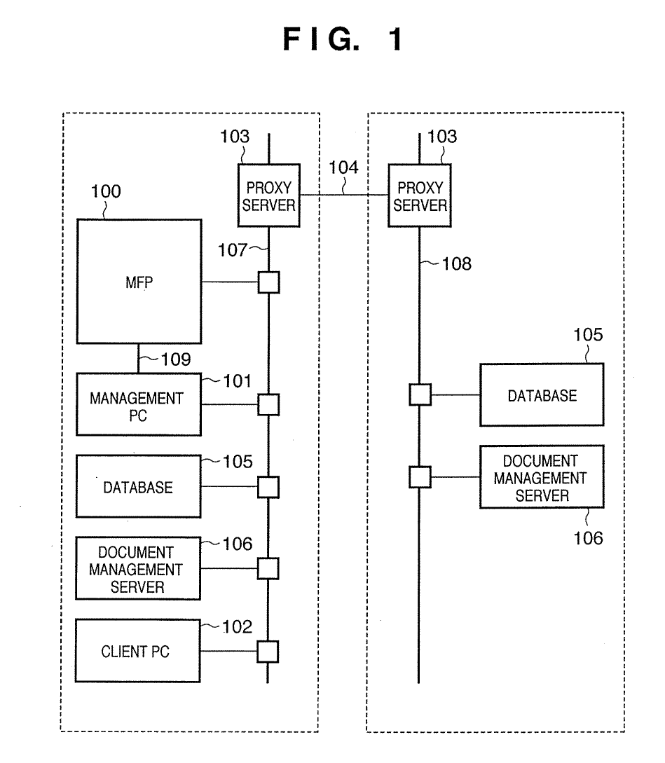

FIG. 1 is a block diagram showing an exemplary configuration of a printing system according to one embodiment of the present invention. The printing system shown in FIG. 1 is implemented in an environment in which an office 10 is connected with another office 20 over a network 104 such as the Internet.

Connected onto a LAN 107 provided in the office 10 are a multifunction printer (MFP) 100, a management personal computer (PC) 101 which controls the MFP 100, a client PC (external storage) 102, a document management server 106, its database 105, and a proxy server 103. The LAN 107 and a LAN 108 in the office 20 are connected onto a network 104 through the proxy server 103. The MFP 100 in this embodiment is responsible for scanning images on hard copy documents and part of image processing of read image signals, and uses a LAN 109 to input the image signals into the management PC 101. The management PC 101, which is a typical PC, contains components such as an image storage, an image processor, a display, and an input unit. Part of the management PC 101 is integrated in the MFP 100.

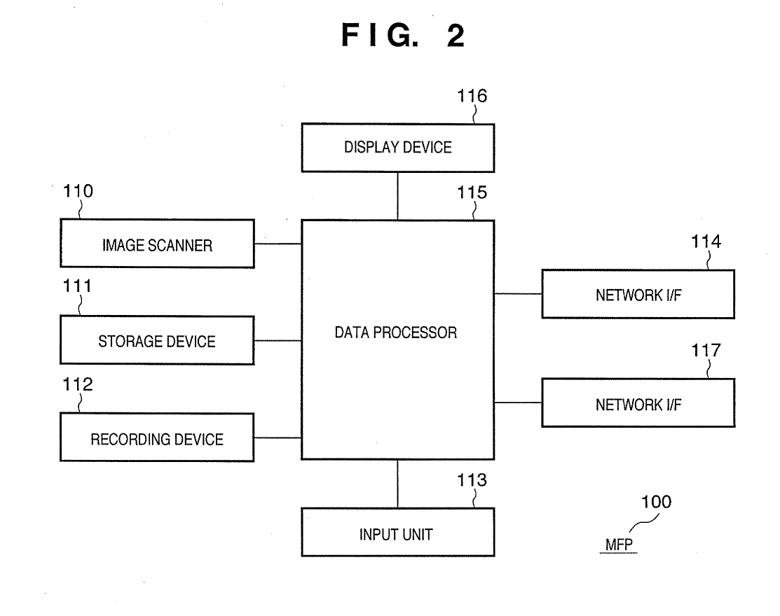

FIG. 2 is a block diagram showing a configuration of an MFP 100 according to one embodiment of the present invention. In FIG. 2, an image scanner 110, which includes an automatic document feeder (ADF), irradiates an original image on a bundle or sheet of paper with light from a light source, which is not shown, to form a reflected image on a solid-state image sensing device through a lens. Then the image scanner 110 obtains a raster scan signal from the solid-state image sensing device as, for example, image information with a resolution of 600 DPI. In the case of an ordinary copy function, image processing is applied to the image signal in a data processor 115 to convert it in a record signal; for a multi-copy function, recorded data is temporarily held in a recording device (printer) 111 page by page, then sequentially outputted to a recording device (storage device) 112 to generate an image on paper.

On the other hand, print data outputted from the client PC 102 is provided from LAN 107 through a network interface 114 to the data processor 115, where the print data is converted into a recordable raster data, and the raster data is formed as a recorded image on paper in the recording device 112.

A operator command to the MFP 100 is provided through a key operation unit provided on the MFP 100 and an input unit 113 which consists of a keyboard and a mouse coupled to the management PC 101. This series of operation is controlled by a controller, not shown, in the data processor 115.

The status of input operation and image data being processed are displayed on a display 116. The storage device 111 is also controlled by the management PC 101. Data exchange and control between the MFP 100 and the management PC 101 are performed through the use of a network interface 117 and LAN 109, which is directly connected.

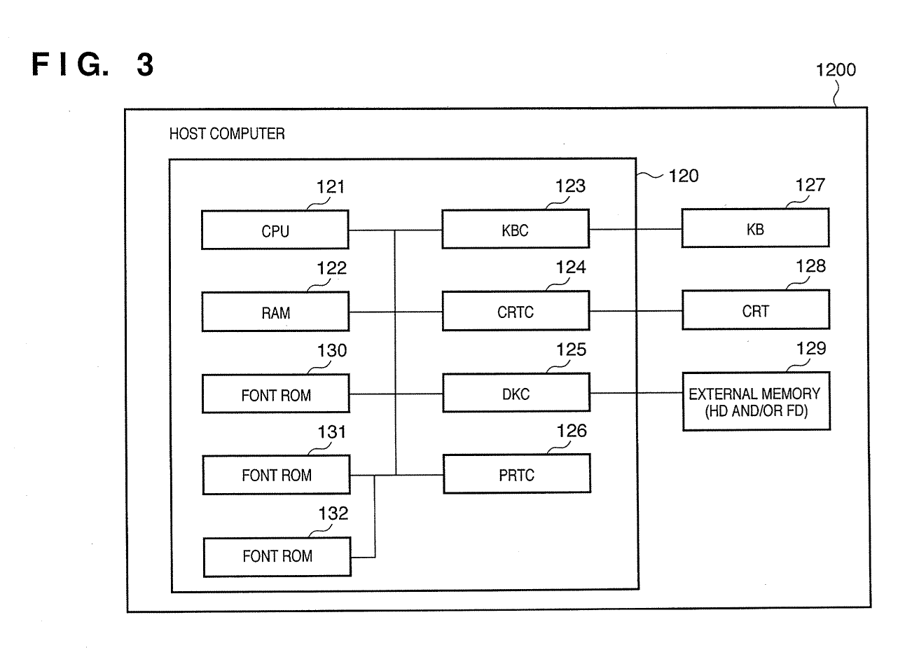

FIG. 3 shows a configuration of a computer capable of functioning as a host computer 1200 such as a management PC 101 or a client PC 102. As shown in FIG. 3, the host computer 1200 includes a CPU 121, a RAM 122, ROMs 131, 132, 133, a keyboard controller (KBC) 123, and a CRT controller (CRTC) 124. The host computer 1200 also includes a disk controller (DKC) 125, a printer controller (PRTC) 126, a keyboard (KB) 127, a CRT display (CRT) 128, and an external memory 129.

Components of the host computer 1200 will be described in detail below. The CPU 121 is a central processing unit which centrally controls the devices connected onto a system bus 120. The CPU 121 performs processing of documents containing graphics, images, text, and tables (including spreadsheets) in accordance with a program, such as a document processing program, stored in a program ROM 132 among the ROMs 131, 132, and 133 or an external memory 129.

The CPU 121 opens various kinds of registered windows in response to commands pointed to by a cursor such as a mouse cursor on the CRT display 128 and executes various types of data processing. When using the MFP 100 to perform printing, a user can open a window for print settings and can make print settings on a printer driver, including settings of the MFP 100 and selection of a print mode.

The RAM 122 functions as the main memory, work area and others for the CPU 121. The ROMs 131, 132, 133 include a font ROM 131, a program ROM 132, and a data ROM 133. The font ROM 131 or the external memory 129 stores font data used in document processing. The program ROM 132 or the external memory 129 stores an operating system (OS) or the like, which is a control program for the CPU 21. The data ROM 133 or the external memory 129 stores various kinds of data used in document processing.

The keyboard controller (KBC) 123 controls key inputs from the keyboard 127 and a pointing device. The CRT controller (CRTC) 124 controls display on the CRT display 128. The disk controller (DKC) 125 controls access to the external memory 129. The printer controller (PRTC) 126 is connected to the MFP 100 through a bidirectional interface and controls communications with the MFP 100. The keyboard 127 includes various keys.

The CRT display (CRT) 128 displays, graphics, images, text, and tables and the like. The external memory 129 includes storages such as hard disk (HD) and a flexible disk (FD). The external memory 129 stores a boot program, applications, font data, user files, edit files, a printer control command generation program (hereinafter referred to as the “printer driver”), and other programs and data.

The CPU 121, RAM 122, ROMs 131, 132, 133, keyboard controller 123, CRT controller 124, disk controller 125, and printer controller 126 are provided on a computer control unit.

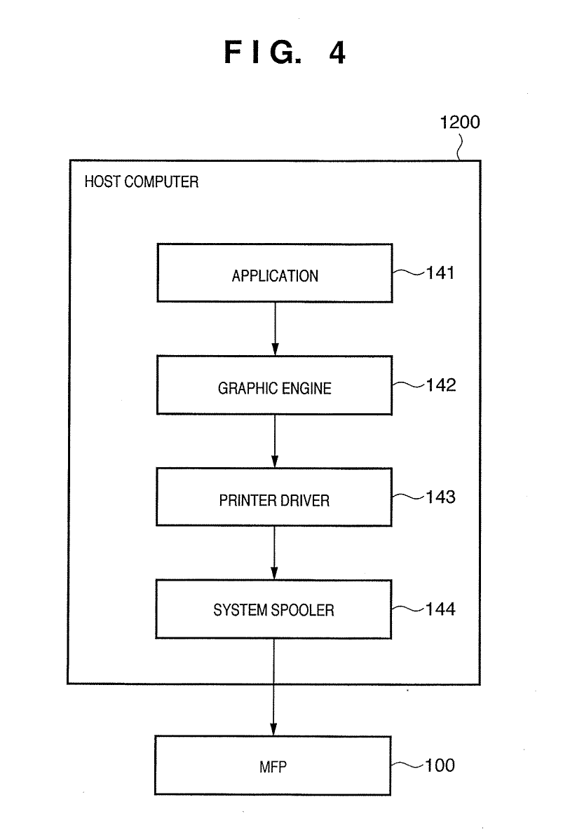

FIG. 4 is a block diagram showing a configuration of a typical printing system including a host computer 1200 to which a printer such as an MFP 100 is connected directly or through a network. In FIG. 4, an application 141, a graphic engine 142, a printer driver 143, and a system spooler 144 are files stored in the external memory 129 shown in FIG. 3. When any of these program modules is to be executed, the module is loaded by the OS or another module that uses that module into the RAM 122 and is then executed.

An application 141 and a printer driver 143 can be added to the HD, which is an external memory 129, through an FD or CD-ROM, which is an external memory 129, or through the network. The application 141 stored in the external memory 129 is loaded into the RAM 122 and is executed. When printing is performed on the MFP 100 from the application 141, the graphic engine 142, which is also loaded in the RAM 122 and is ready to be executed, is used to provide an output (generate images).

Similarly, the graphic engine 142 loads a printer driver 143 for each printer from an external memory 129 to the RAM 122 and sets the output of the application 141 to the printer driver 143. The graphic engine 142 then converts a GDI (Graphic Device Interface) function received from the application 141 to a DDI (Device Driver interface) function and provides the DDI function to the printer driver 143. The printer driver 143 converts the DDI function received from the graphic engine 142 into a control command, for example a PDL (Page Description Language) command, that can be recognized by the printer. The converted printer control command is outputted to the MFP 100 as print data through the system spooler 144 loaded in the RAM 122 by the OS.

[Overview of Printing in Host Computer 1200]

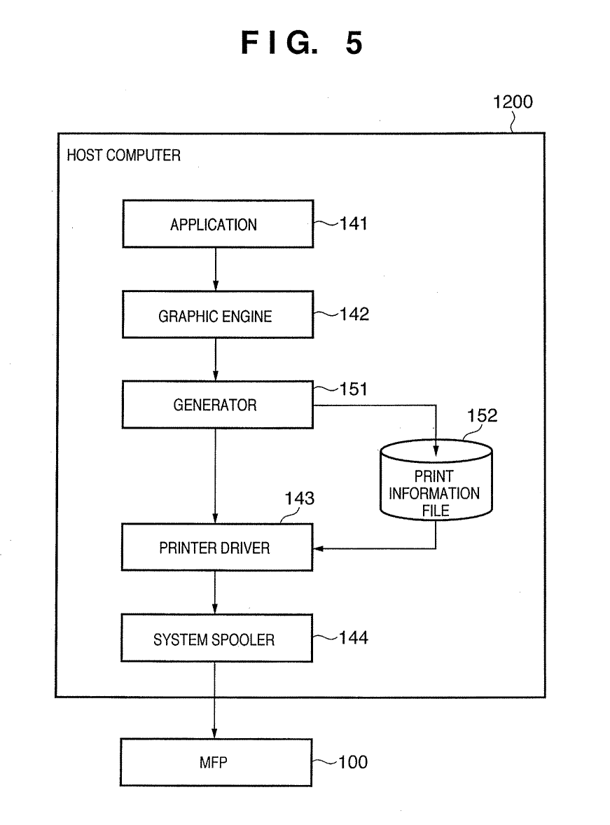

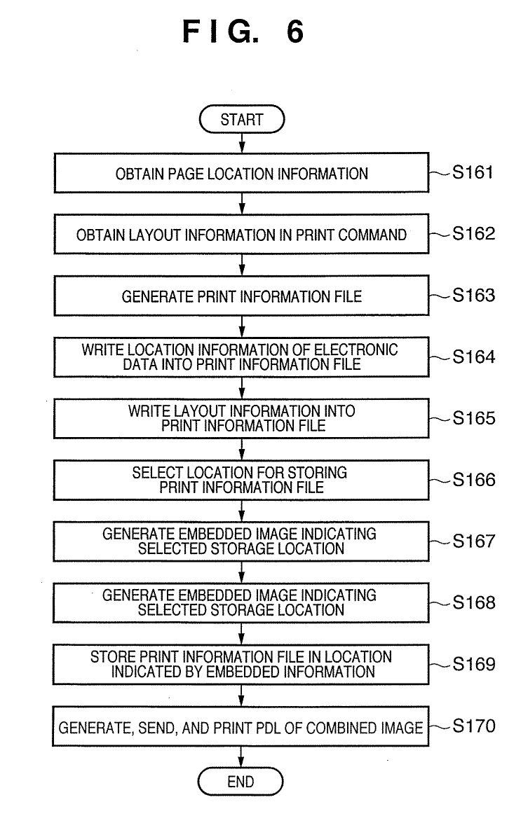

A printing system according to one embodiment of the present invention has a configuration that writes various kinds of information used in printing into a file and holds the information in the file, as shown in FIGS. 5 and 6. Referring to FIGS. 5 and 6, a printing process will be described in detail below.

FIG. 5 is a block diagram showing a configuration of an extended version of a typical printing system including a host computer 1200 shown in FIG. 4. FIG. 6 is a flowchart illustrating a printing process performed by the printing system shown in FIG. 5. In the printing system shown in FIG. 5, a generator 151 first receives a print command from a graphic engine 142. The generator 151 then extracts and holds the location information of multiple electronic documents to be printed and information about pages contained in the print command (information such as page numbers) from the print command (step S161). If information to extract is not contained in the print command, the generator 151 accesses the application 141 to obtain the required information. The generator 151 also extracts and holds layout information used for printing (step S162). Again, if required information is not contained in the print command, the generator 151 accesses the application 141 to obtain the required information. It should be noted that multiple electronic documents are different files and the locations of the electronic documents are also different.

The generator 151 then generates a print information file 152 (step S163) and writes the information and parameters obtained at steps S161 and S162 into a print information file 152 (steps S164 and S165). Then the generator 151 determines a location to store the print information file 152. The location may be in a hard disk in the client PC, a database 105 of a document management server 106 connected, or a storage device 111 of the MFP 100 itself. If any of these storage location is specified in advance, the generator 151 determines to store the print information file in that location (step S166). If no location is specified, the generator 151 may select an appropriate storage location according to the processing capability of the device. The electronic documents are stored in different locations.

Next, the generator 151 generates an image indicating the location selected at step S166 (step S167). The image indicating the location may be a two-dimensional barcode or an object equivalent to an IP-address or path information or may be information embedded between characters. Alternatively, a digital watermark that is hidden in a halftone image and invisible to human eyes may be used. The image indicating the location information generated at step S167 is embedded in the original print command (step S168). Then, the generated print information file 152 is stored in the location selected at step S166 (step S169). It may be stored by using a well-known technique such as FTP. Finally, the image is converted into PDL of the image in which the location information generated at step S168 is embedded and sent to the MFP 100, where the printing is performed (step S170).

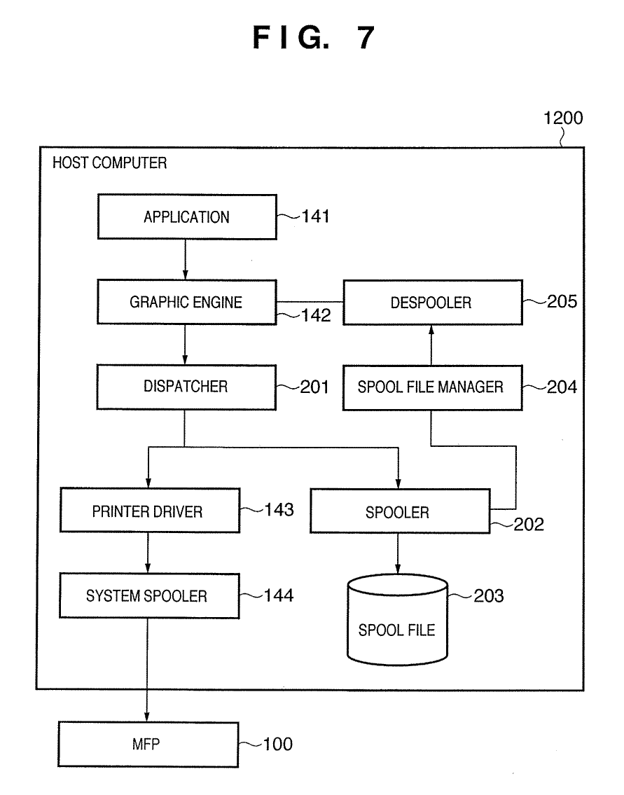

FIG. 7 is a block diagram showing a configuration of an extended version of the typical printing system including a host computer 200 shown in FIG. 4. In the printing system shown in FIG. 7, before a print command is sent from a graphic engine 142 to a printer driver 143, a spool file 203 consisting of an intermediate code is generated first. In the system in FIG. 4, the application 141 is not freed from a printing job until the printer driver 143 converts all print commands provided from the graphic engine 142 into control commands for an MFP 100. In the system shown in FIG. 7 in contrast, the application 141 is freed from a printing job once a spooler 202 converts all print commands into intermediate code data and outputs it to a spool file 203. Generally, the later process takes shorter time.

Furthermore, in the system shown in FIG. 7, modifications can be made to the spool file 203. Thus, functions that are not included in an application can be applied to print data provided from the application, such as scaling and N-up printing which enables reduced images of multiple pages to be printed in a single page.

To achieve the functions, the system shown in FIG. 4 is extended as shown in FIG. 7 so that intermediate code data is spooled. To modify print data, typically a setting is made in a window provided by the printer driver 143, which then stores the setting in a RAM 122 or an external memory 129.

The printing system shown in FIG. 7 will be described below in detail. In the extended system, a dispatcher 201 receives a print command from the graphic engine 142 as shown in FIG. 7. If the print command received by the dispatcher 201 from the graphic engine 142 is a print command issued from an application 141 to the graphic engine 142, the following process is performed. The dispatcher 201 loads a spooler 202 stored in an external memory 129 into the RAM 122. The dispatcher 201 then sends the print command to the spooler 202, instead of the printer driver 143.

The spooler 202 converts the print command it received into an intermediate code and outputs it into the spool file 203. The spooler 202 obtains from the printer driver 143 a setting for modifying the print data that is made on the printer driver 143 and stores it in the spool file 203. It should be noted that while the spool file 203 is generated as a file in the external memory 129 in this embodiment, it may be generated in the RAM 122. The spooler then loads a spool file manger 204 stored in the external memory 129 into the RAM 122 and notifies the spool file manger 204 of the status of generation of the spool file 203.

Next, the spool file manager 204 determines whether the printer driver 143 can generate print data in accordance with setting information concerning the print data stored in the spool file 203. The spool file 203 manages the intermediate data in each logical page outputted by the application 141. The spool file 203 manages modification settings, for example a layout setting (printing based on settings such as N-up printing or single/double side printing) that were made on the printer driver 143 by a user as described above. Therefore, determination as to whether the printer driver 143 can generate print data is made as follows. If all logical pages required for printing based on the modification settings stored in the spool file 203 are managed in the spool file 203, it means that all data required for generating print data is available. Accordingly, it can be determined that the print data can be generated.

If the spool file manger 204 determines that the printer driver can generate the print data using the graphic engine 142, the spool file manger 204 loads the despooler 205 stored in the external memory 129 into the RAM 122. The spool file manger 204 then directs a despooler 205 to perform printing of the intermediate data described in the spool file 203.

The despooler 205 modifies the intermediate code contained in the spool file 203 in accordance with layout information indicated by the spool file manger 204, converts the modified intermediate data to a GDI function, and outputs it to the graphic engine 142. The despooler 205 makes modifications as described below. The despooler 205 draws each object to be drawn in a logical page on the basis of the logical page obtained from the spool file 203 and the layout information obtained from the spool file manager 204. The despooler 205 converts the intermediate data thus modified and obtained to a GDI function and provides it to the graphic engine 142.

The graphic engine 142 generates a DDI function from the GDI function received from the despooler 205 and outputs a print command consisting of the DDI function to the dispatcher 201. If the print command consisting of the DDI function received by the dispatcher 201 from the graphic engine 142 is a print command consisting of a GDI function issued from the despooler 2005 to the graphic engine 142, the dispatcher 201 sends the print command to the printer driver 143 instead of the spooler 202. The printer driver 143 generates print data consisting of printer control commands on the basis of the print command it received and outputs it to the MFP 100 through the system spooler 144.

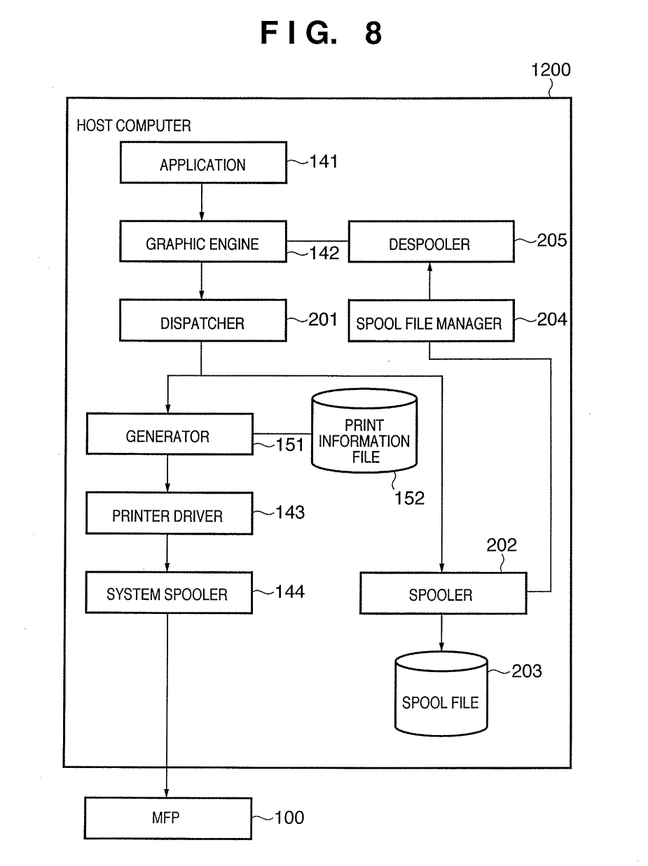

A printing system according to the present embodiment may have a configuration shown in FIG. 8. FIG. 8 is a block diagram showing a configuration of an extended version of the typical printing system including a host computer 1200 shown in FIG. 7. This system writes and holds in a file a print command received from a graphic engine 142 containing various kinds of information used in each print job and settings for modifying print data received from a spool file manger 204. The process will be described in detail with reference to FIGS. 8 and 6.

In the printing system shown in FIG. 8, a print command is sent as follows. If a print command of a DDI function received by a dispatcher 201 from a graphic engine 142 is a print command of a GDI function issued from a despooler 205 to the graphic engine 142, the dispatcher 201 sends the print command to a generator 151 instead of a spooler 202. If the generator 151 receives a print command of a GDI function issued from the despooler 205 to the graphic engine 142, the generator 151 extracts and holds the location of an electronic document to print and information about pages contained in the print command (information such as the page number) from the print command (step S161).

The generator 151 also extracts and holds layout information used for printing obtained from a spool file manger 204 (step S162) when the printing reflecting the layout information is to be performed. The generator 151 then generates a print information file 152 (step S163) and writes the information and parameters obtained at steps S161 and S162 into the print information file 152 (steps S164 and S165). The generator 151 determines a location to store the print information file 152. The location may be in a hard disk of the client PC, a database 105 of a document management server 106 connected, or a storage device 111 of the MFP 100 itself. If any of these storage locations is specified in advance, the generator 151 determines to store the print information file in that location (step S166). If no location is specified, the generator 151 may select an appropriate storage location according to the processing capability of the device.

Next, the generator 151 generates an image indicating the location selected at step S166 (step S167). The image indicating the location may be a two-dimensional barcode or an object equivalent to an IP-address or path information or it may be information embedded between characters. Alternatively, a method that provides information that is not directly visible may be used, such as the so-called electronic watermarking in which information is hidden in a halftone image. The image indicating the location information generated at step S167 is embedded in the original print command (step S168). Then, the generated print information file 152 is stored in the location selected at step S166 (step S169). It may be stored by using a well-known technique such as, for example, FTP. Finally, the image is converted into PDL of the image in which the location information generated at step S168 is embedded and is sent to the MFP 100, where the printing is performed (step S170). While electronic documents are stored in determined locations in the printing process described above, electronic documents that are already stored may be specified and printed. In this case, information indicating the location of the specified electronic document is written in the print information file. Furthermore, one electronic document may be stored in a specified location during a printing process and another stored electronic document may be specified.

[Reprinting]

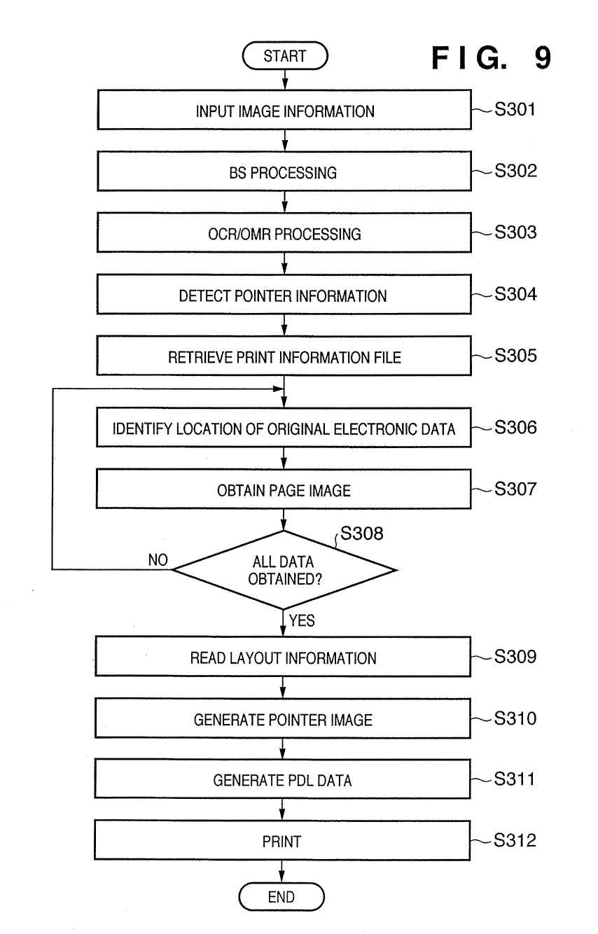

A process for reprinting a hard copy printed by using the printing process described above will be described below with reference to FIG. 9. FIG. 9 is a flowchart illustrating a reprinting process performed in a printing system according to one embodiment of the present invention. As shown in FIG. 9, first an image scanner 110 in an MFP 100 is operated to raster-scan one original sheet to obtain an 8-bit image signal at a resolution of 600 DPI in an image information input step (step S301).

Next, the image signal is pre-processed in a data processor 115 and stored as image data in one page in a storage device 111. The CPU of a management PC 101 first separates the area of the page into a text/line drawing portion and halftone image portion and further segments the text portion into blocks separated as paragraphs, or tables or graphics consisting of lines. The image portion represented by halftone is divided into rectangular image blocks, that is, objects such as background objects that are separate blocks (step S302).

In doing this, an object representing a two-dimensional barcode or an URL recorded as additional information in the original image is detected. Then, if a URL is detected, it is recognized through OCR; if a two-dimensional barcode is detected, the mark is decoded (step S303) to find pointer information pointing to a location in a storage device where a print information file 152 is stored (step S304). The pointer information may be added by embedding it in a space between characters or by using electronic watermarking that hides the information in a halftone image in such a manner that it is not directly visible.

If pointer information is detected, the print information file 152 is retrieved from the address pointed to by the pointer. The print information file 152 is stored in any of a hard disk of the client PC 102, a database 105 of a document management server 106 connected onto the LAN 107, and a storage device of the MFP 100 itself. The storages are searched for the print information file 152 using the address information obtained at step S303 to retrieve the information file 152 (step S305). Then the locations of electronic documents written from the print information file 152 and page information (information such as page numbers) contained in the print command are obtained (step S306). All page images specified at step S306 are obtained (step S307).

After all specified page images are obtained, layout information written out is obtained (step S309). The layout information obtained here may be layout information received from the application 141 or layout information received from the despooler 205, whichever has been written out.

Next, an image indicating the location pointed to by the pointer information obtained at step S304 is generated. The image indicating the location is generated by using the same technique that was used at step S303 (step S310) The layout of the page images obtained at step S307 is changed on the basis of the layout information obtained at step S309 to generate print images. The images generated at step S310 are combined, the image data is converted into PDL and is then sent to the MFP 100 (step S311). The MFP 100 receives the PDL and prints in a conventional manner (step S312).

[Block Selection]

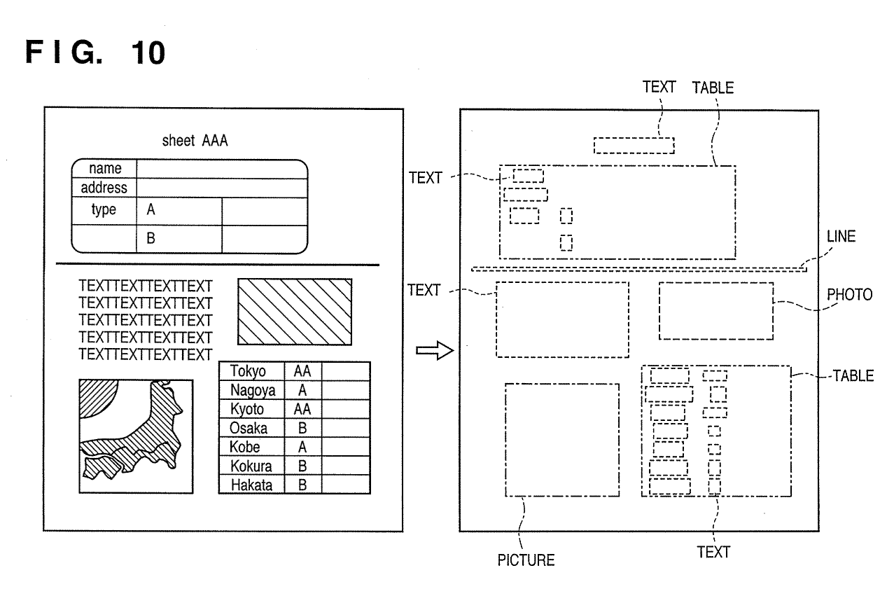

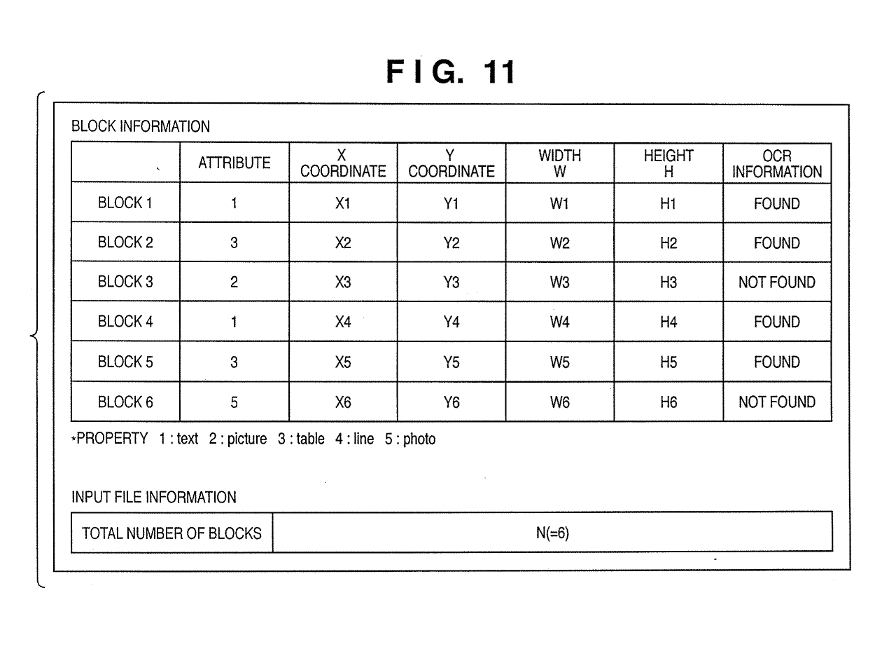

FIG. 10 shows an example of image data processing in block selection processing. FIG. 11 shows block information recognized as a result of the block selection. Block selection is processing for recognizing image data in one page read at step S301 as clusters of objects as indicated by reference numeral 1001 in FIG. 10. Each of the blocks is classified as an attribute such as text, graphic, photograph, line, or table, thereby dividing the page into regions with different attributes.

An example of the block selection processing will be described below.

First, an input image is binarized into black and white and outline tracing is performed to extract clusters of pixels enclosed by a black-pixel outline. For a cluster of black pixels that occupies a large area, outline tracing of white pixels inside the area is performed to extract a cluster of white pixels. For a cluster of white pixels that occupies an area greater than a predetermined value, clusters of black pixels inside the area are extracted recursively.

The clusters of black pixels thus obtained are classified into regions with different attributes according to size and shape. A cluster of black pixels in regions having a horizontal to vertical ratio near 1 and smaller than a predetermined size, for example, is classified as clusters of black pixels equivalent to text. Among the text-equivalent clusters, a cluster of black pixels in which adjacent characters can be grouped in a well-aligned manner is further classified as text region and a cluster of black pixels that is flat is classified as line region. Furthermore, a region that is occupied by a cluster of black pixels, is greater than or equal to a predetermined size, and encloses a rectangular cluster of well-aligned white pixels is classified as table region, a region in which irregular clusters of pixels are scattered is classified as photograph region, and the other regions having arbitrary shapes are classified as graphic area.

Block information about the blocks obtained as a result of the block selection processing is shown in FIG. 11. The information about the blocks will be used for a search, which will be described later.

[Pointer Extraction]

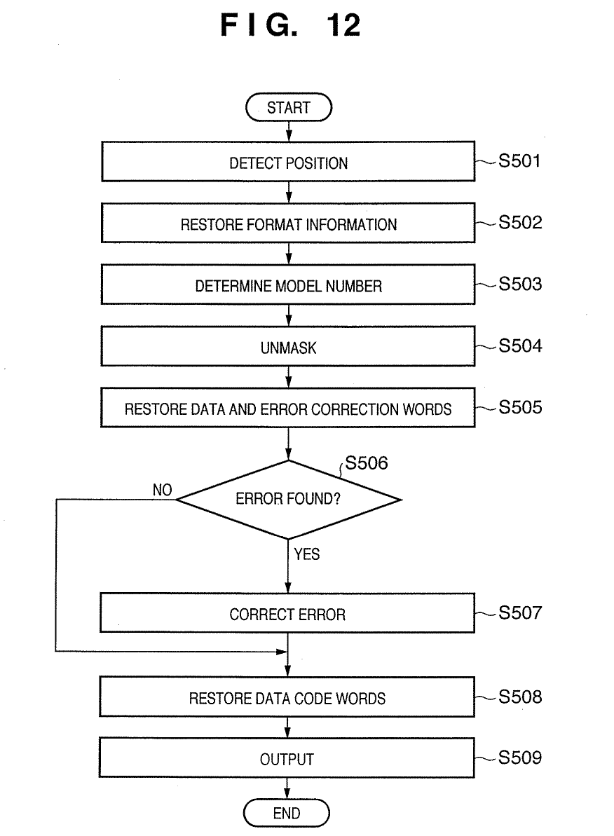

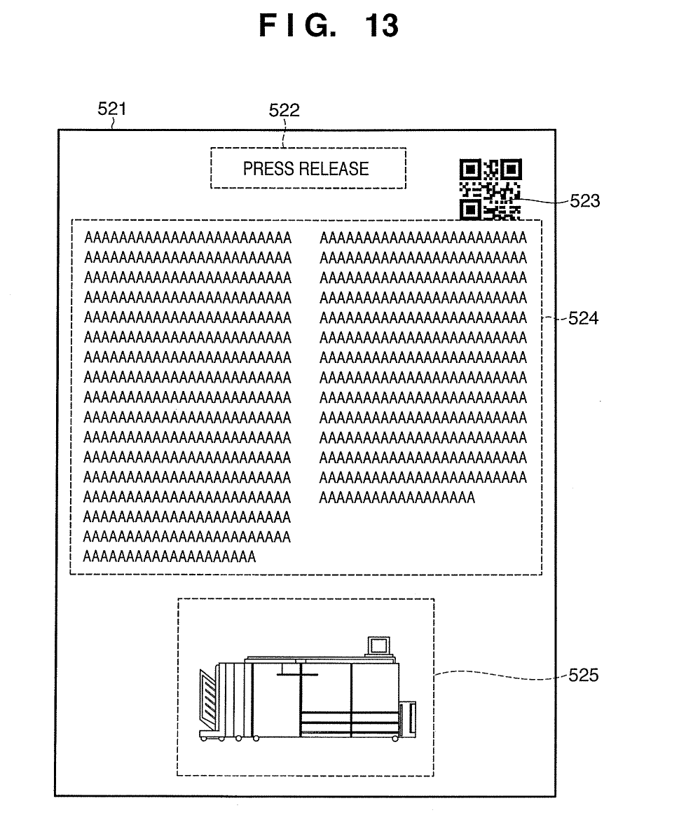

OCR/OMR processing, shown at step S303, for extracting the storage location of a file from image information will be described below. FIG. 12 is a flowchart illustrating a process for decoding a two-dimensional barcode (QR code symbol) embedded in an original image to provide a data character string. FIG. 13 shows an example of an original 521 in which a two-dimensional barcode is embedded.

First, the CPU scans an image representing an original 521 stored in a page memory in a data processor 115 and detects the position of a given two-dimensional barcode symbol 522 from the result of block selection processing described above. The position detection pattern of the QR code consists of an identical position detection pattern disposed in three of the four corners of the symbol (step S501).

Format information adjacent to the position detection pattern is then restored to obtain the error correction level and mask pattern (step S502) applied to symbols. The model number of the symbol is determined (step S503). Then, the mask pattern obtained from the format information is used to perform XOR of the coded region bit pattern to unmask the symbol (step S504).

Symbol characters are read according to the arrangement rule associated with the model to restore the data and error code words of the message (step S505). Then the restored code is checked for an error (step S506). If an error is detected, the process proceeds to step S507, where the error is corrected. The data code word in the error-corrected data is segmented on the basis of the mode indicator and character count indicator (step S508). Finally, the data characters are restored on the basis of the specification mode and the result is outputted (step S509).

The data included in the two-dimensional barcode represents the address information of an associated file, which may be path information consisting of, for example, a file server name and a file name. Alternatively, the data may be a URL to an associated file.

While the example has been described with respect to an original 521 to which the pointer information is added by using a two-dimensional barcode, the present invention is not so limited. If the pointer information is recorded by directly using a character string, for example, the block of the character string according to a predetermined rule is detected in the block selection processing described above. Then each character in the character string indicating the pointer information can be recognized using character recognition processing to directly obtain address information of the original file.

Alternatively, invisible modulation can be applied to the space between characters in a character string in block 522 or 524 in a document 521 shown in FIG. 13 to embed information in the space, thus adding pointer information In the case of watermark information, the space between characters can be detected during character recognition processing, which will be described later, to obtain the pointer information. Pointer information can be embedded in a natural image 525 as an electronic watermark.

[File Search Using Pointer Information]

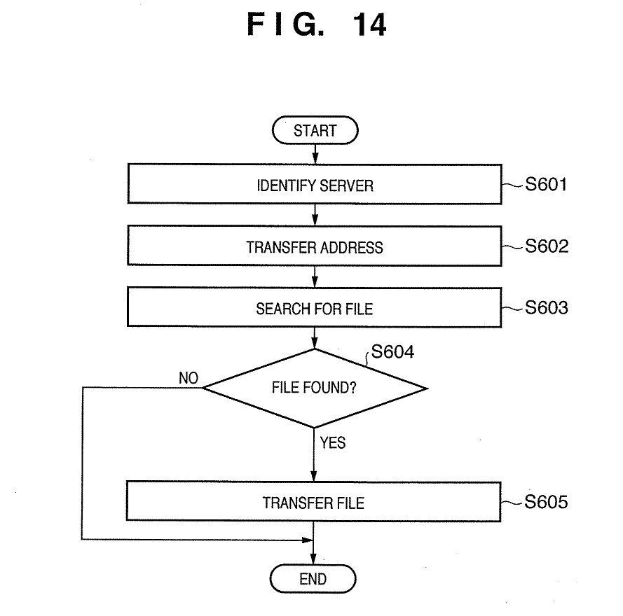

FIG. 14 is a flowchart illustrating details of the process for searching for an electronic file using pointer information at step S305 described with reference to FIG. 9. First, a file server is identified from the address included in the pointer information (step S601). Here, the file server is a client PC 102, a document management server 106 containing a database 105, or the MFP 100 itself containing a storage device 111. The address is a URL or path information consisting of a server name and file name.

After the file server is identified, the address is transferred to the file server (step S602). When receiving the address, the file serer searches for the corresponding file (step S603) to determine whether the file exists (step S604). If the file is not found (No), the file server so notifies the MFP 100. On the other hand, if the file is found (Yes), the file server notifies the address of the file to the MFP 100 and, if the user wants to obtain image file data, also transfers the file to the MFP 100 (step S605).

In the printing system described above, location information of electronic data in a page that has been printed can be held and layout information used in the printing can also be held. If the amount of information to hold is huge, the information can be written to a separate file. Thus, a large amount of information can be held without increasing the size of an embedded image.

In the printing system described above, information relating to electronic documents can be held and the information relating to the electronic documents can be obtained when the documents are to be copied. Accordingly, the documents can be reprinted. With this, print images with higher quality can be provided.

Moreover, in the printing system described above, electronic data and layout information of a page that has been printed can be treated in reprinting in a manner similar to the printing. Accordingly, print images with hither quality can be provided.

The initial printing for generating a print information file may be performed as follows, instead of printing from a host computer through a printer driver. A user operation section of an MFP or management PC may be operated to specify a number of electronic documents and specify printing formats such as a layout to generate a print information file when printing, in the same way as described above, and the print information file may be stored.

While examples in which electronic documents are obtained based on print information file and printed have been described above, such electronic documents may be transferred to another device by specifying the destination, instead of printing them or may be otherwise outputted.

The present invention can prevent increases in the amount of data embedded in electronic documents if the amount of information relating to the electronic documents to print becomes large.

### Other Embodiments

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code itself installed in the computer also implements the present invention. In other words, the claims of the present invention also cover a computer program for the purpose of implementing the functions of the present invention.

In this case, so long as the system or apparatus has the functions of the program, the program may be executed in any form, e.g., as object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

Further, it is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Furthermore, besides the case where the aforesaid functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-347936 filed Dec. 1, 2005, which is hereby incorporated by reference herein in its entirety.

What is claimed is:

1. A printing system printing an electronic document that is a combination of a plurality of electronic documents on a printer, comprising:
a writing unit adapted to write a related information relating to the plurality of electronic documents that includes storage location information of the plurality of the electronic documents into a file;
a storage unit adapted to store the file in the printing system;
an adding unit adapted to generate, on the basis of the plurality of electronic documents according to the related information, a print image of the electronic document to which an image of the storage location of the file is added; and
a print unit adapted to print and output the print image on a printing medium.

2. The printing system according to claim 1, wherein the writing unit writes storage location information of a particular page of the electronic document into the file as the related information.

3. The printing system according to claim 1, wherein the writing unit writes layout information of the electronic document into the file as the related information.

4. The printing system according to claim 1, wherein the writing unit writes into the file layout information used when a plurality of print jobs to be printed are combined and printed out, as the related information.

5. The printing system according to claim 1, wherein the storage unit stores the file in a storage device held by a host computer that has issued a print command to print the electronic document.

6. The printing system according to claim 1, wherein the storage unit stores the file in a storage medium held by the printer that prints out the print image.

7. The printing system according to claim 1, wherein the adding unit adds the storage location information of the file to the electronic document by using a barcode.

8. The printing system according to claim 1, wherein the adding unit adds the location information of the file to the electronic document as an image hardly visible to human eye.

9. The printing system according to claim 1, further comprising:
an image obtaining unit adapted to scan the print medium printed out by the printing unit to obtain image information;
an added image extracting unit adapted to extract the storage location information of the file added by the adding unit from the image information; and
a file obtaining unit adapted to obtain the file written by the writing unit from the storage location identified by the storage location information.

10. The printing system according to claim 9, further comprising:
a print information obtaining unit adapted to obtain print information required for printing the plurality of electronic documents from the file obtained by the file obtaining unit; and
a second printing unit adapted to search for and print the plurality of electronic documents on the basis of the print information.

11. The printing system according to claim 10, wherein the print information obtaining unit obtains storage location information and layout information of a particular page of the electronic document.

12. A printing method in a printing system printing an electronic document that is a combination of a plurality of electronic documents on a printer, comprising the steps of:
writing related information relating to the plurality of electronic documents that includes storage location information of the plurality of electronic documents into a file;
storing the file in the printing system;
generating, on the basis of the plurality of electronic documents according the related information, a print image of the electronic document to which an image of the storage location information of the file is added; and
outputting the print image on the printer to print out the print image on a printing medium.

13. A computer-readable storage medium storing a computer program for causing a computer to perform the printing method according to claim 12.
